(19) United States
(12) Patent Application Publication
(10) Pub. No.: US 2007/0279286 A1
(43) Pub. Date: Dec. 6, 2007

(54) Multi-Mode Antenna Array

(75) Inventors: Gordon Coutts, Waterloo (CA); Raafat Mansour, Waterloo (CA); Sujeet Chaudhuri, Heidelberg (CA); Wai-Cheung Tang, Mannheim (CA)

Correspondence Address: CONLEY ROSE, P.C.;David A. Rose, P. O. BOX 3267, HOUSTON, TX, 77253-3267, US

(73) Assignee: MARK IV INDUSTRIES CORP., (CA)

(21) Appl. No.: 11/422,238

(22) Filed: Jun. 5, 2006

(51) Int. Cl. H01Q 1/38

(52) U.S. Cl. 343/700 MS

(57) ABSTRACT

A multi-mode parasitic antenna array having two or more resonant frequencies. The multi-mode parasitic antenna array has at least two resonant modes resulting in substantially divergent radiation patterns, thereby providing the antenna with frequency dependent directivity. The array may be incorporated into a tag for an RFID system. The RFID system includes a reader capable of interrogating the tag at each of the resonant frequencies.

### FIELD OF THE INVENTION

The present invention relates to radio frequency (RF) antennas and, in particular, a steerable multi-mode antenna array and radio frequency identification tags and systems incorporating the antenna array.

### BACKGROUND OF THE INVENTION

Radio frequency identification (RFID) technology is now being used to track a wide variety of items. In many RFID systems, the tag may be located in any direction and may be in any orientation, so the tag antenna preferably has a nearly omni-directional radiation pattern. The most simple antenna design used in creating a cost-effective tag antenna is a dipole. A simple dipole antenna features a toroidal radiation pattern at its resonant frequency, meaning that the antenna gain and sensitivity is diversely spread over a wide beam shape. The toroidal pattern also features a null point at either axial end of the dipole.

In order to increase the sensitivity and range of an antenna, the antenna may be designed to have a narrower beam shape, i.e. a more directive radiation pattern. However, this results in a larger range of null areas in which the antenna cannot communicate. Accordingly, narrow beam shape is typically not desirable for RFID applications, since RFID tags may often be oriented in any random position relative to a reader,

In some cases, for applications outside of RFID, RF antenna designers have attempted to produce wider bandwidth antennas. One approach has been to create a multi-mode antenna having multiple resonant frequencies. Each resonant frequency has its own characteristic radiation pattern. In the case of these designs, the objective of the designer has been to configure the antenna to minimize the pattern variation with frequency. The object of a wideband antenna of this nature is to provide consistent coverage across a range of frequencies.

It would be advantageous to provide for an antenna array and/or an RFID system or RFID tag that provides increased communications range.

### SUMMARY OF THE INVENTION

The present invention provides a multi-mode antenna array having two or more resonant frequencies. The multi-mode antenna array has at least two resonant modes that produce substantially divergent radiation patterns, thereby providing the antenna with frequency dependent directivity and beam steering. The antenna array may be incorporated into an RFID tag.

The present invention also provides an RFID system and method for communicating with a tag having the multi-mode array antenna. The RFID system includes a reader capable of interrogating the tag at each of the resonant frequencies.

By configuring the tag antenna to have multiple narrower beam patterns of divergent directivity, the antenna provides for an extensive communications range through a broad spectrum of orientations. Even though, for a given orientation, the tag may not be capable of communicating at all resonant frequencies, it may be capable of communicating with at least one of its resonant frequencies. The more focused directivity of the radiation pattern for a given frequency means that the range of communication for the tag is greater than would be possible using the equivalent dipole antenna

In one aspect, the present invention provides an antenna for radio frequency communications. The antenna includes an active radiating element, two or more additional radiating elements coupled to the active radiating element, and a feed port connected to the active radiating element at a location. The antenna has a first resonant frequency with a first radiation pattern and a second resonant frequency with a second radiation pattern, and the first radiation pattern and the second radiation pattern are substantially divergent in at least one plane. In one embodiment, the location of the feed port and the coupling of the additional radiating elements to the active element provide the antenna with at least two resonant modes corresponding to the first resonant frequency and the second resonant frequency, respectively.

In another aspect, the present invention provides a radio frequency identification (RFID) tag for use in an RFID system having a reader. The tag includes an RFID transceiver and an antenna array having at least a first resonant frequency and a second resonant frequency. The first resonant frequency has a first radiation pattern and the second resonant frequency has a second radiation pattern, and the first radiation pattern and the second radiation pattern are substantially divergent in at least one plane, The antenna array has a feed port and the RFID transceiver includes a signal port connected to the feed port of the antenna array.

In another aspect, the present invention provides a radio frequency identification (RFID) system. The system includes a tag including an RFID transceiver and an antenna array having at least a first resonant frequency and a second resonant frequency The first resonant frequency has a first radiation pattern and the second resonant frequency has a second radiation pattern, and the first radiation pattern and the second radiation pattern are substantially divergent in at least one plane. The antenna array has a feed port and the RFID transceiver includes a signal port connected to the feed port of the antenna array The system also includes a reader. The reader has a reader antenna and a reader transceiver. The reader transceiver is configured to generate a first signal at the first resonant frequency and a second signal at the second resonant frequency The reader transceiver is coupled to the reader antenna for exciting the reader antenna to propagate RF energy to the tag at the first resonant frequency and the second resonant frequency.

In yet another aspect, the present invention provides a method of conducting RFID communications between a reader and one or more tags each having a multi-mode antenna array. The array has a first resonant frequency and a second resonant frequency. The reader is configured to generate and propagate RF signals at the first resonant frequency and the second resonant frequency. The method includes the steps of propagating an interrogation signal at the first resonant frequency from the reader, receiving a first response signal at the first resonant frequency, propagating the interrogation signal at the second resonant frequency from the reader, and receiving a second response signal at the second resonant frequency.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows an example embodiment of an RFID system;

FIG. 2 shows, in flowchart form, an example method 5 for selecting a frequency for RFID communications between a reader and a tag;

FIG. 3 diagrammatically shows one embodiment of a multi-mode parasitic RFID antenna array;

FIG. 4 diagrammatically shows a simulated radiation pattern for the antenna at 5.65 Ghz;

FIG. 5 diagrammatically shows a simulated radiation pattern for the antenna at 5.81 Ghz;

FIG. 6 diagrammatically shows a simulated radiation pattern for the antenna at 6.2 Ghz;

FIG. 7 shows a graph of reflection coefficient at the antenna feedpoint as a function of frequency;

FIG. 8 shows a second example embodiment of a multi-mode parasitic antenna array;

FIG. 9 shows a third example embodiment of a multi-mode parasitic antenna array;

FIG. 10 shows a fourth example embodiment of a multi-mode parasitic antenna array;

FIG. 11 shows a fifth example embodiment of a multi-mode parasitic antenna array,

FIG. 12 shows a sixth example embodiment of a multi-mode parasitic antenna array;

FIG. 13 shows a perspective view of an example embodiment of a multi-layer multi-mode parasitic antenna array;

FIG. 14 shows a top plan view of the antenna from FIG. 13;

FIG. 15 shows an example embodiment of an actively switched multi-mode parasitic antenna array; and

FIG. 16 diagrammatically shows a wideband combining network with several antenna elements

Similar reference numerals are used in different figures to denote similar components.

### DESCRIPTION OF SPECIFIC EMBODIMENTS

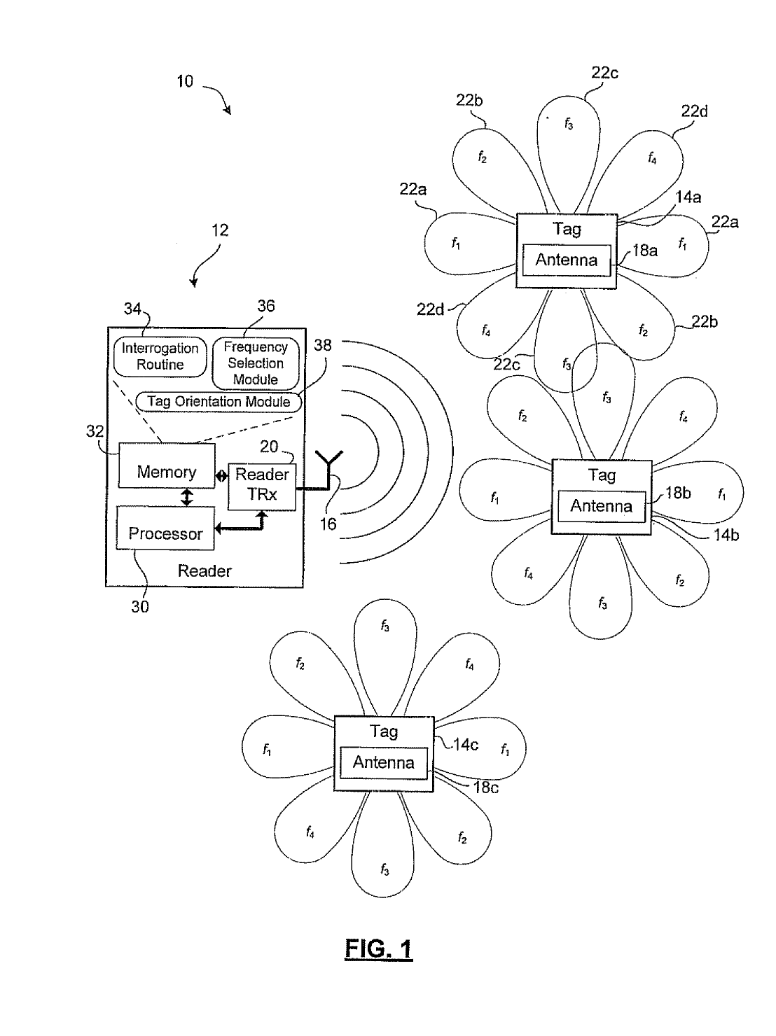

Reference is first made to FIG. 1, which shows an example embodiment of an RFID system 10 according to the present description The system 10 includes a reader 12 and a plurality of tags 14 (shown individually as 14a, 14b, and 14c). The reader 12 and the tags 14 communicate using RF signals In some embodiments the each tag 14 may be attached to or associated with consumer products such as individual articles of clothing, accessories, consumer electronics, household items, etc. The tags 14 may store data regarding the item with which they are associated For example, in some embodiments the tags 14 may store information that conforms to Electronic Product Code (EPC) standards regarding product identification Nevertheless, the present RFID system 10 is not limited to use in connection with tracking inventory items and may be used in any other application of RFID technology

The reader 12 includes a transceiver 20 and a reader antenna 16. The transceiver 20 and reader antenna 16 enable the reader 12 to propagate RF signals at two or more frequencies. The antenna 16 may comprise a multi-mode antenna capable of resonating at more than one frequency. In some embodiments, the antenna 16 may comprises two or more separate antennas each having one or more distinct resonant frequencies. The transceiver 20 generates RF electrical signals for exciting the antenna 16 and generating the propagating RF signal The transceiver may selectively generate RF electrical signals at one of two or more possible frequencies, so as to excite the antenna 16 to generate a propagating RF signal at one of the two or more selectable frequencies

In many embodiments, the item tags 14 are passive devices that use backscatter modulation to communicate with the reader 12. In other embodiments, the item tags 14 may be active devices having integrated power sources, such as a battery, for generating and transmitting RF signals to the reader 12. In any event, each tag 14 includes an antenna 18 (shown individually as 18a, 18b, and 18c) for receiving incoming RF signals from the reader 12 and for propagating outgoing RF signals to the reader 12.

In some embodiments, the reader 12 interrogates the tags 14 by sending an RF signal and each tag 14 responds by transmitting stored information to the reader 12 from a memory within the tag 14. The configuration of the reader 12 and the tags 14 and the protocols for engaging in interrogation and response are well understood. In one embodiment, the tags 14 include EPC information, as described in Auto-ID Center publication Draft Protocol Specification for a 900 MHz Class 0 RFID, Feb. 23, 2003, the contents of which are incorporated herein by reference. It will be appreciated that anti-collision mechanisms may be employed to enable the reader 12 to read the item information from each of the tags 14,

FIG. 1 diagrammatically illustrates the radiation patterns associated with the antenna 18 of each tag 14. In particular, the antenna 18 of each tag 14 comprises a multi-mode antenna array having two or more resonant frequencies. Each of the two or more resonant frequencies has a characteristic radiation pattern, resulting in multiple radiation patterns for the antenna 18. At least two of the resonant frequencies result in substantially divergent radiation patterns, in at least one plane. In other words, at different frequencies, the antenna 18 produces a distinctive radiation pattern having substantially distinctive directivity.

For example, as illustrated in FIG. 1, the multi-mode antenna 18 features four resonant frequencies, f₁, f₂, f₃, and f₄. For each frequency the antenna 18 has a high-gain radiation pattern 22 (shown individually as 22a, 22b, 22c, 22d), as illustrated in FIG. 1. The high-gain radiation patterns 22 have a distinctive directivity, resulting in increased antenna sensitivity for that frequency over a relatively small beam width. Each radiation pattern 22 is substantially divergent from at least one other radiation pattern 22 in at least one plane. As a result, the ability of the antenna 18 to send or receive RF signals from any given direction is frequency dependent. Although four resonant frequencies are shown in FIG. 1, it will be appreciated that other embodiments of the tag 14 may feature an antenna having more or fewer resonant frequencies

In the example embodiment illustrated, the radiation pattern 22a corresponding to frequency f₁ is substantially divergent from the radiation patterns 22 of each of the other frequencies. For example, the radiation pattern 22a of frequency f₁ is substantially orthogonal to the radiation pattern 22c of frequency f₃. It is also approximately 45 degrees divergent from radiation pattern 22b of frequency f₂ and radiation pattern 22d of frequency f₄. The antenna 18 may have substantial overlap between radiation patterns for a pair of its resonant frequencies, especially in the case where the antenna 18 has a large number of resonant frequencies, provided that the radiation patterns for at least two of the resonant frequencies of the antenna 18 are substantially divergent. The antenna 18 is constructed and configured such that the radiation patterns for its various resonant frequencies are sufficiently directive, i.e, narrow beam, and sufficiently divergent among themselves, as to provide the antenna 18 with frequency dependent directivity.

Within the RFID system 10, the frequency dependent directivity of the antenna 18 radiation pattern means that the position and orientation of each tag 14 relative to the reader 12 determines the frequency at which the antenna 18 is best able to communicate In other words, in each orientation relative to the reader, one of the resonant frequencies of the antenna 18 may have higher gain, i.e. antenna sensitivity, relative to the other resonant frequencies Depending on the overlap between radiation patterns, the tag 14 may be capable of communicating with the reader 12 at more than one frequency in a given orientation and position Nevertheless, at most orientations or positions the antenna sensitivity with respect to one of the frequencies is likely to be dominant.

Referring still to the example embodiment shown in FIG. 1, tag 14a is positioned and oriented such that the radiation pattern 22d for frequency f₄ appears to be substantially directed towards the reader 12, Accordingly, in this orientation, communications between the tag 14a and reader 12 are most likely to be successful using frequency f₄ Conversely, the radiation pattern 22b for frequency f₂ appears to be the least directed towards the reader 12 and, thus, communications between the tag 14a and reader 12 using frequency f₂ may have a more limited range (e.g. distance apart) and/or may not be operable at all.

The tag 14b is oriented such that the radiation pattern 22a corresponding to frequency f₁ is the pattern most directed towards the reader 12. As a result, the tag 14b and reader 12 are best able to communicate using frequency f₁.

The tag 14c is oriented such that the radiation pattern 22c corresponding to frequency f₃ is the pattern most directed towards the reader 12. As a result, the tag 14c and reader 12 are best able to communicate using frequency f₃.

In one embodiment the tags 14 are passive RFID tags, meaning that they do not have an independent power source and employ backscatter modulation to communicate with the reader 12. In this embodiment, the frequency dependent directivity of the antenna 18 results in the tag 14 having a greater sensitivity to RF transmissions from the reader 12 at a given frequency for a given orientation. Moreover, when the reader 12 transmits RF energy at the given frequency the increased sensitivity of the tag antenna 18 means that a greater degree of the RF energy is induced in the antenna 18 resulting in a higher amplitude RF signal in the tag 14, as compared to passive tags having antennas with wide beam sensitivity The higher amplitude RF energy results in higher amplitude reflected energy from the backscatter modulation process, which leads to higher energy RF output from the antenna 18 back to the reader 12.

Similarly, in an active tag embodiment, the frequency dependent directivity of the tag antenna 18 leads to greater sensitivity to the RF energy transmitted by the reader 12 at the given frequency, i.e. It also means that the RF signal generated and sent by the tag 14 back to the reader 12 has a greater proportion of its energy directed to the reader 12, resulting in a better range,

Accordingly, irrespective of whether the tag is passive or active, the frequency dependent directivity of the antenna 18 results in a greater range for tag-reader communications using the appropriate frequency.

Referring still to FIG. 1, the RFID system 10 may include a mechanism for selecting the appropriate frequency for further communications between the reader 12 and one of the tags 14.

In one embodiment, the reader 12 determines the most appropriate frequency for communicating with a given tag. The reader 12 may base the frequency selection upon one or more response signals received by the reader 12 from the tag 14 in response to interrogation signals broadcast by the reader 12. For example, the reader 12 may broadcast an interrogation signal at a first frequency, await a response from any tags 14 in range of the signal, and then repeat with a second frequency, and so on, through all of the resonant frequencies of the antennas. The reader 12 may then, for each individual tag, select a communications frequency based upon the signal strength of response signals from that individual tag at the various frequencies. The response signal having the greatest signal strength indicates the frequency whose radiation pattern is likely most directed at the reader 12.

As an example, the reader 12 in FIG. 1 may sequentially broadcast interrogation signals at frequencies f₁, f₂, f₃, and f₄. For example, the reader 12 may first broadcast a signal at frequency f₁. If the tags 14 are passive tags, then the broadcast of the interrogation signal includes broadcasting a continuous wave RF signal at the frequency f₁ so that the tag 14 can respond by backscatter modulating the RF signal, i.e. switching between and absorptive and reflective characteristic. After a predetermined period during which the reader 12 receives response signal(s), if any, the reader 12 then broadcasts another interrogation signal at the next frequency It will be appreciated that the interrogation/polling and response process may further include anti-collision handling to deal with responses from multiple tags 14, as will be appreciated by those of ordinary skill in the art. For simplicity, those techniques are not discussed in this disclosure, and it will be presumed for this example that a single tag is in range of the reader 12. Persons of ordinary skill in the art will appreciate the techniques and mechanisms for coping with collision issues in RFID communications.

After cycling through the frequencies at least once, the reader 12 may then determine which frequency was the most successful for communicating with a given tag 14. For example, with respect to tag 14a, the reader 12 may receive response signals from the tag 14a in reply to interrogation signals at frequencies f₁, f₃, and f₄. The reader 12 may not receive any response from the tag 14a in reply to an interrogation signal at frequency f₂. The response signals at frequencies f₁ and f₃ may have lower signal strength than the response signal at frequency f₄, since the tag 14a will receive lower induced energy from interrogation signals at frequencies f₁ and f₃ than the interrogation signal at frequency f₄, and the reflected energy from the tag 14a at frequency f₄ is more concentrated upon the reader 12 than the reflected energy at frequencies f₁ and f₃. Accordingly, the reader 12 may determine that frequency f₄ is the preferred frequency for communicating with tag 14a. Accordingly, any subsequent communications between the tag 14a and the reader 12 may be conducted using frequency f₄.

Similarly, with respect to tag 14b, the reader 12 may determine that frequency f₁ is the preferred frequency. With respect to tag 14c, the reader 12 may determine that frequency f₃ is the preferred frequency. It will be appreciated that in some orientations a given tag 14 may have two radiation patterns each partially oriented towards the reader 12, such that either frequency may be used for subsequent communications. A similar situation may arise as a result of multipath issues.

In another embodiment, the reader 12 may be configured to send interrogation signals at all relevant frequencies and may employ anti-collision mechanisms for dealing with multiple response signals.

Referring still to FIG. 1, the reader 12 may include a processor 30 and memory 32. The memory 32 may include volatile and non-volatile data storage As will be appreciated by those skilled in the art, the memory 32 may include applications, routines, modules, or other programming constructs, that may be loaded into a temporary or volatile memory location for execution by the processor 30. The processor 30 includes various input and output ports coupling it to the memory 32 and to the transceiver 20

The reader 12 may include an interrogation routine 34. The interrogation routine 34 may be implemented as an application, module, object, subroutine, or other programming construct to provide computer-executable instructions for execution upon the processor 30 to implement the RFID interrogation/polling routine in accordance with this description. For example, the interrogation routine 34 may be configured to cause the reader 12, and in particular the transceiver 20, to serially broadcast polling signals at a plurality of frequencies and to receive response signals thereto

Response signals received by the transceiver 20 may, in one embodiment, be digitized and temporarily stored in memory 32. In another embodiment, the transceiver 20, among its other functions, measures the signal strength of an incoming response signal and the signal strength data is temporarily stored in memory 32. The signal strength data may be stored in memory 32 in association with tag identification information, such as a tad ID or serial number, and with frequency information identifying the frequency of the response signal.

The reader 12 may further include a frequency selection module 36 for determining the frequency to be used by the reader for any subsequent communications with the tag 14. For simplicity, the frequency selection module 36 is illustrated as a distinct component in FIG. 1. It will be appreciated that the frequency selection module 36 may be implemented as a stand-alone module or application, as a part of the interrogation routine 34, or as a part of any other software program or operating system within the reader 12. It may be implemented as a programming object, script, subroutine, or other programming construct.

The frequency selection module 36 may select a frequency for subsequent communications with the tag 14 based upon the signal strength of response signals received from the tag 14 during execution of the interrogation routine 34A In one embodiment, where signal strength data has been stored in memory 32, the frequency selection module 36 may be configured to read the signal strength data from memory 32 and select the frequency having the greatest signal strength.

In yet another embodiment, the reader 12 may include a tag orientation module 38 for determining the orientation of the tag 14 based upon the response signals received by the reader 12 at the various frequencies. The tag orientation module 38 may be configured to determine the likely orientation of the tag based upon relative signal strength date stored in memory.

Those of ordinary skill in the art will also appreciate that some of the components of the reader 12 described as being distinct from the transceiver 20, such as the frequency selection module 36 and the interrogation routine 34, may in some embodiments be implemented within the transceiver 20,

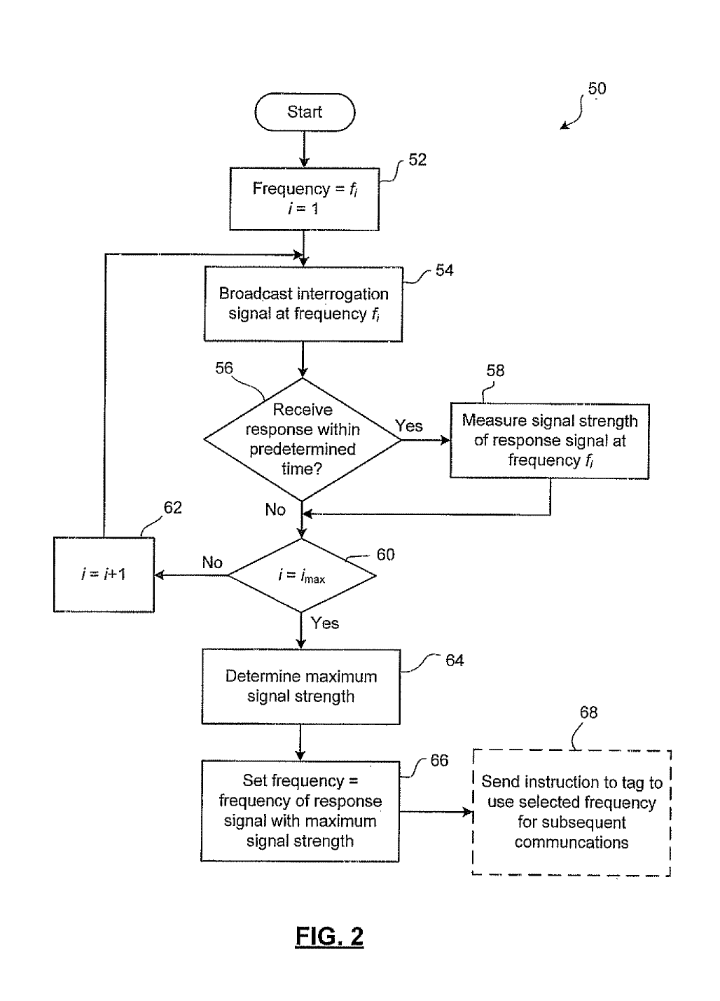

Reference is now made to FIG. 2, which shows, in flowchart form, an example method 50 for selecting a frequency for RFID communications between a reader 12 (FIG. 1) and a tag 14 (FIG. 1). The method 50 may be implemented, in some embodiments, through suitable programming of the processor 30 (FIG. 1) and/or configuration of the transceiver 20 (FIG. 1). For example, the method 50 may be implemented by way of the interrogation routine 34 (FIG. 1) and frequency selection module 36 (FIG. 1).

The method 50 begins in step 52 with the initialization of certain parameters. For example, an index value i is set to its initial value, which in this example is 1. The frequency generated by the reader 12 is designated fᵢ. The index is used to refer to one of the resonant frequencies of the tag antenna 18 (FIG. 1). For example, if the tag 14 is capable of communications at three different frequencies, then the index may range from 1 to 3 to indicate the three different frequencies f₁, f₂, and f₃. These may be referred to as the “candidate frequencies” below.

In step 54 the reader 12—and in particular the transceiver 20 (FIG. 1)—generates and broadcasts an interrogation signal at frequency fᵢ, The interrogation signal may conform to a standard or format for the particular RFID communications applicable to a given embodiment. For example, in some embodiments the interrogation signal may include trigger pulses or wake-up pulses that inform the tag that it should awaken and respond. The interrogation signal may, in the case of passive tags, include the broadcast of a continuous wave RF signal at the frequency fᵢ. Other characteristics of the interrogation signal may be dependent upon the particular application or predetermined RFID communications protocol.

In step 56 the reader 12 listens for a response signal at frequency fᵢ and determines whether such a response signal is received from a tag 14 in the broadcast range of the reader 12 within a predetermined time period The reader 12 may conclude that no tags are present if no response signal is received in the predetermined time period, which may be set in accordance with the predetermined RFID communications protocol. If no response signal is received, then the method 50 continues at step 60; otherwise, it continues to step 58.

At step 58, the reader 12 measures the signal strength of the response signal received at frequency fᵢ. The measured signal strength value may be stored in memory for later use. The signal strength measurement may further be associated with the particular tag and the frequency fᵢ. For example, the response signal may include tag information from the tag memory. The tag information may include tag identification information, such as a tag ID number or serial number. After step 58, the method 50 continues at step 60.

In step 60, the reader 12 determines whether it has cycled through all the candidate frequencies—i.e. whether index i has reached its maximum. If not, then the index is incremented in step 62 and the method 50 returns to step 54 to repeat the interrogation routine with the next frequency fᵢ.

It will be appreciated that steps 54, 56, and 58 are, in some embodiments, performed concurrently by the reader 12 It will also be appreciated that the steps 54, 56, and 58 may incorporate collision detection and avoidance routines to handle instances where more than one tag responds to an interrogation signal at a time. These routines may include imposing random response delays at the tags and/or other mechanisms for enabling the reader to receive multiple responses. In some cases, these routines may require that the reader repeat the steps 54, 56, and 58 for each frequency fᵢ multiple times.

After the tag(s) have been interrogated at each of the candidate frequencies, then from step 60 the method 50 proceeds to step 64. At step 64, the reader 12 determines, for each tag that responded to an interrogation signal, the maximum signal strength amongst the response signals received from that tag. The signal strength measurements for each response signal may be stored in memory as result of step 58.

By way of example, response signals from tag X may have been received at frequencies f₂ and f₃, but no response may have been received at frequency f₁. At step 64, the reader 12 determines whether the tag's response signal at frequency f₂ or the response signal at frequency f₃ has the higher signal strength. The reader 12 then, at step 66, selects the frequency identified in step 64 as the frequency to use for any further communications directed to tag X.

It will be appreciated that steps 64 and 66 may be performed for each tag 14 from which the reader 12 received at least one response signal.

In one embodiment, the method 50 may include a further step 68, shown in dashed outline, of instructing the tag to communicate using the selected frequency In the case of a passive tag, this step may not be required since the tag 14 can only response by using the frequency broadcast by the reader 12. In the case of an active tag, if the tag 14 is capable of generating RF signals at more than one frequency, then the instruction from the reader 12 may cause the tag 14 to configure itself to generate any further RF signals at the selected frequency for the duration of the communications session with the reader 12.

In yet another embodiment, the tag 14 may detect and select the frequency for communication by measuring the signal strength of each interrogation signal received over the course of a cycle through the candidate frequencies, and selecting the frequency corresponding to the strongest interrogation signal. The tag 14 may then respond to the reader 12 using the selected frequency.

It will be appreciated that the RFID system 10 (FIG. 1) described above features one or more tags 14 (FIG. 1) having a multi-mode antenna 18 (FIG. 1) with frequency dependent directivity. In one embodiment, the tag antenna 18 includes at least one active element and at least two parasitic elements, giving rise to multiple resonances wherein two resonant frequencies have substantially divergent radiation patterns. The parasitic elements may be electrically or magnetically coupled to the active element.

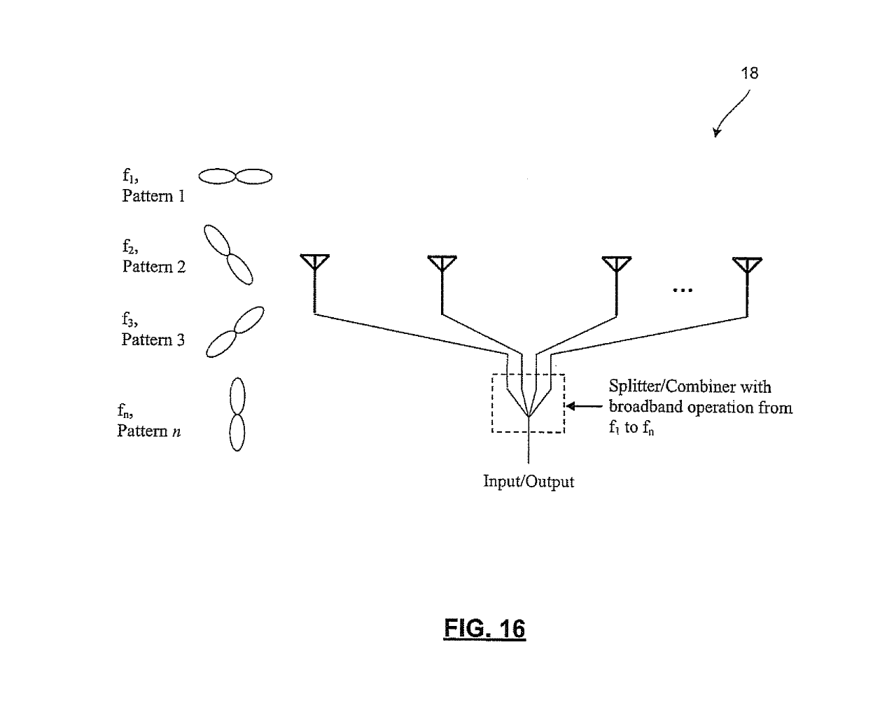

Conceptually, the multi-mode parasitic antenna 18 may be understood as a wideband combining network, as illustrated in FIG. 16. The wideband combining network includes a plurality of antennas each having a resonant frequency, such that the antenna 18 has resonant frequencies f₁ to fₙ. The antennas are conceptually combined/multiplexed by way of a splitter/combiner with broadband operation from f₁ to fₙ. In the context of the antenna 18 each of the antennas 1 to n may represent a different resonant mode and/or different resonant structures. Through a combination of physical spacing of the structures or elements and the consequent electromagnetic coupling between those structures or elements, the antenna 18 may be configured to have multiple resonant frequencies having divergent radiation patterns.

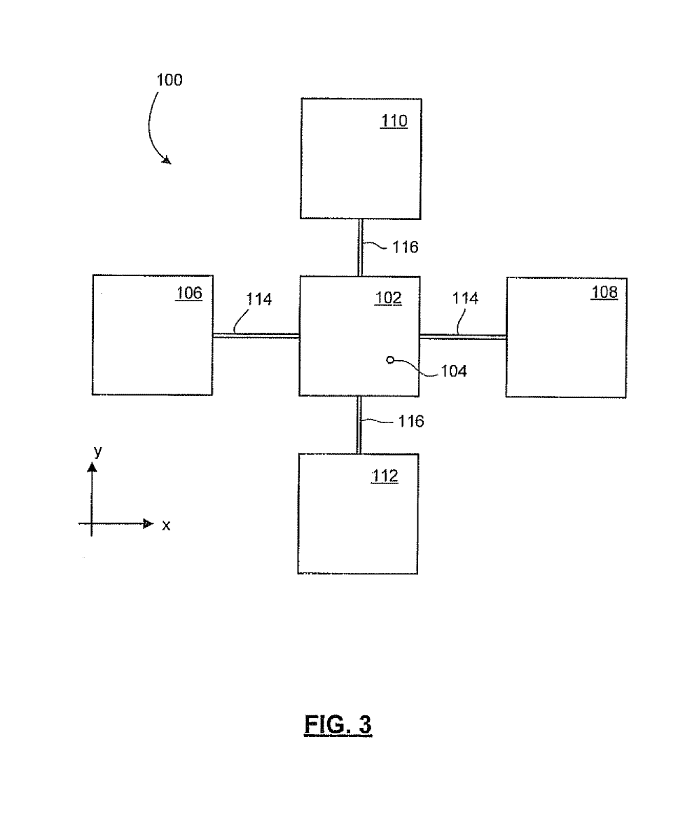

Reference is now made to FIG. 3, which diagrammatically shows one embodiment of a multi-mode parasitic antenna 100 according to the present disclosure. The antenna 100 comprises a parasitic patch array having a central patch 102 connected to a feed point 104 In the following description, the feed point 104 may also be referred to as a feed port,

The patch array is constructed using direct coupled parasitic patches surrounding the central patch 102. In particular, the antenna 100 includes a first parasitic patch 106 and a second parasitic patch 108 arranged in an x-direction on either side of the central patch 102. These patches 102, 106, and 108 act as coupled resonators, having a resonant frequency at a first frequency. At this first resonant frequency, i.e. first resonant mode, the edges of the central patch 102 adjacent the first and second parasitic patches 106, 108 act as radiating edges.

The antenna 100 also includes a third parasitic patch 110 and a fourth parasitic patch 112 arranged in an y-direction on either side of the central patch 102. These patches 102, 110, 112, act as coupled resonators, having a resonant frequency at a second frequency At this second resonant frequency, i.e. second resonant mode, the edges of the central patch 102 adjacent the third and fourth parasitic patches 110, 112 act as radiating edges.

The coupling lines 114 connecting patches 102, 106, and 108 in the x-direction have a first length and width and the coupling lines 116 connecting patches 102, 110, and 112 in the y-direction have a second length and width. In some embodiments, the first length may differ from the second length, and the first width may differ from the second width.

The first and second frequency resonances each produce radiation patterns in endfire mode. A broadside mode resonance is produced at a third frequency.

The feed point 104 is, in this embodiment, a single RF coaxial feed port connected to the central patch 102. In order to produce divergent multi-modal resonance, the feed point 104 is not located on either the horizontal or vertical centreline of the central patch 102. In particular, the coaxial feed point 104 is positioned off-centre, partway towards a corner of the central patch 102, yet not on the diagonal It will be appreciated that the location of the feed point 104 will affect the current distribution and, thus, the resonant frequencies of the antenna 100. The feed point 104 location may be selected so as to encourage multi-modal resonance and divergent radiation patterns, for example by placing the feed point 104 such that it is not equidistant from two parallel sides of a polygonal patch, as in this embodiment.

The patches 102, 106, 108, 110, and 112 and coupling lines 114, 116 are formed on the top surface of a substrate A parallel spaced-apart ground plane may be formed on the underside of the substrate. In some instances, such as where the antenna 100 is to be mounted on a metallic surface, the ground plane may be omitted since the metallic surface may serve as a ground plane.

For the purposes of illustration, one particular example embodiment of the antenna 100 will now be described. In this embodiment, each of the patches 102, 106, 108, 110, and 112 are 16.5 mm square patches that have a 5.8 Ghz resonant frequency when isolated. The feed point 104 is connected to the central patch 102 at 4 mm in the x-direction and 5 mm in the y-direction from the lower right corner. The coupling lines 114 that join the first parasitic patch 106 and second parasitic patch 108 to the central patch 102 are 12 mm long and 0.5 mm wide. The coupling lines 116 that join the third parasitic patch 110 and fourth parasitic patch 112 to the central patch 102 are 8 mm long and 0.5 mm wide. The 8 mm and 12 mm dimensions are chosen to isolate the resonant structures from an electromagnetic point of view.

Reference is now made to FIG. 7, which shows a graph 200 of reflection coefficient at the antenna feedpoint as a function of frequency (S11).

The x-direction patches 102, 106, and 108 (FIG. 3) have a resonance at 5.65 GHz, indicated by reference numeral 202. The y-direction patches 102, 110, and 112 (FIG. 3) have a resonance at 5.81 GHz, indicated by reference numeral 204. The broadside resonance is at 6.2 GHz, as indicated by reference numeral 206.

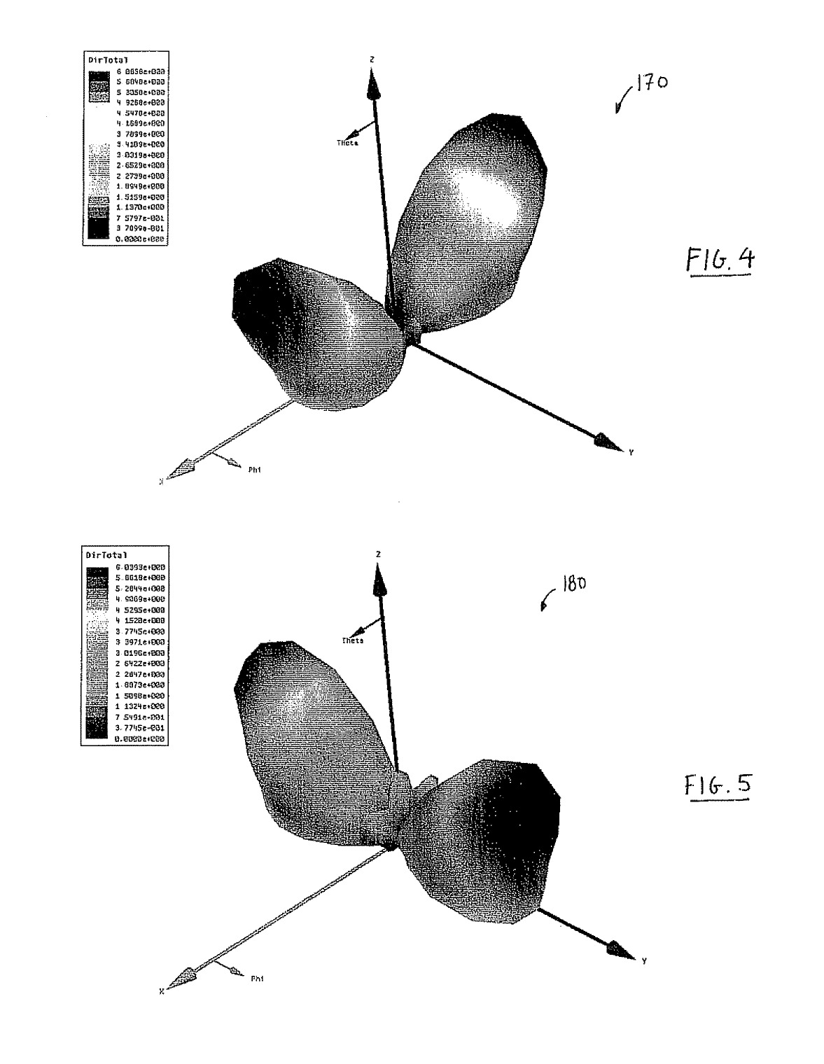

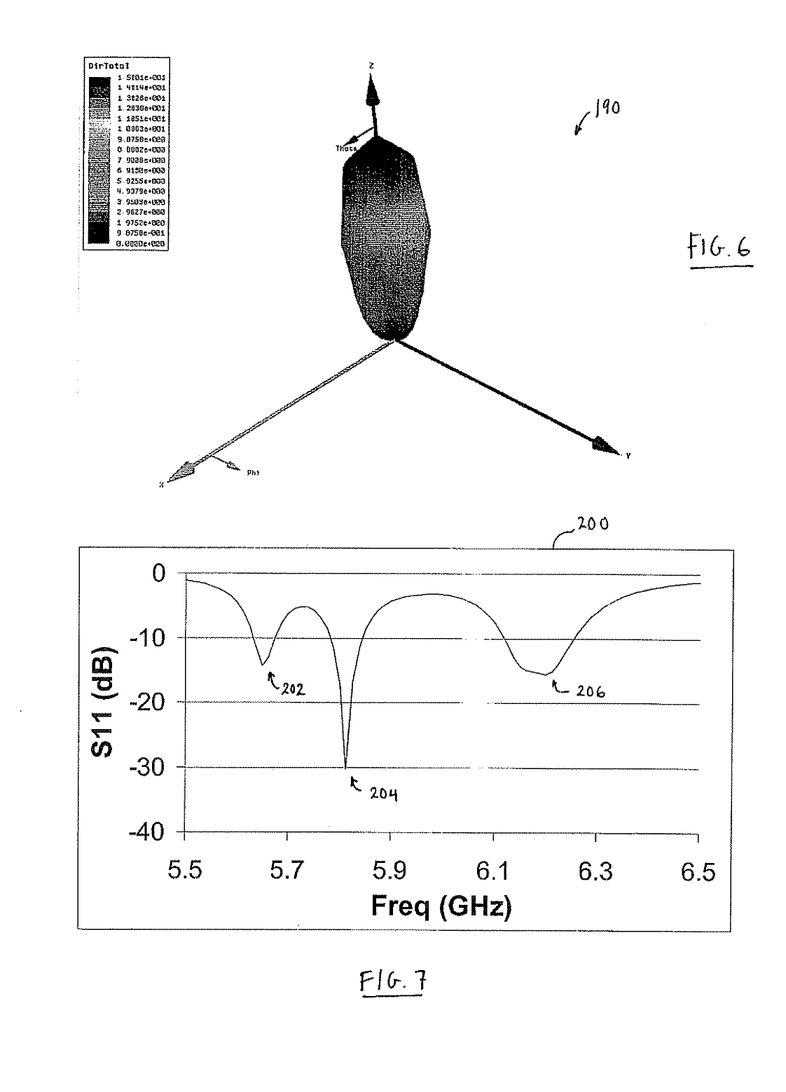

Reference is also now made to FIGS. 4, 5, and 6. FIG. 4 diagrammatically shows a simulated radiation pattern 170 for the antenna 100 (FIG. 3) at 5.65 Ghz. FIG. 5 diagrammatically shows a simulated radiation pattern 180 for the antenna 100 at 5.81 Ghz. FIG. 6 diagrammatically shows a simulated radiation pattern 190 for the antenna 100 at 6.2 Ghz.

The radiation pattern 170 is an endfire mode pattern directed along the x-direction axis. The radiation pattern 180 is an endfire mode pattern directed along the y-direction axis. Accordingly, it will be appreciated that the radiation pattern 170 is substantially divergent from the radiation pattern 180. In fact, in this embodiment, the radiation patterns 170, 180, are substantially orthogonal in the x-y plane.

The radiation pattern 190 is a broadside mode pattern oriented along the z-axis. The radiation pattern 190 is substantially divergent form either the radiation pattern 170 or the radiation pattern 180, although not quite orthogonal in the respective x-z or y-z planes.

With respect to the radiation pattern 170, the simulated directivity is 8.3 dBi, with a gain of 7.6 dBi, corresponding to a radiation efficiency of 85.9%. This gain value corresponds to a 5.4 dB increase in sensitivity compared to a dipole RFID antenna.

With respect to the radiation pattern 180, the simulated directivity is 8.1 dBi, with a 7.5 dBi gain, corresponding to a radiation efficiency of 85.7%. This gain value corresponds to a 5.3 dB increase in sensitivity compared to a dipole RFID antenna.

With respect to the radiation pattern 190, the simulated directivity at 6.2 GHz is 12.0 dBi, with a gain of 11.5 dBi corresponding to a radiation efficiency of 88.1%. This gain value corresponds to a 9.3 dB increase in sensitivity compared to a dipole RFID antenna.

In some embodiments, the antenna 100 may be coaxial fed from the back of the antenna 100. In other embodiments, an RFID chip may be mounted at the feed point 104 on the front of the antenna 100 and, in particular, on the central patch 102. By way of example, the RFID chip may include Philips SL3S1001FTT RFID chip in a TSSOP8 package, although it will be appreciated that other similar chips may be used.

The example antenna 100 described above in connection with FIGS. 3 through 7 comprises a directed coupled parasitic square patch antenna with a single feed point. It will be appreciated that the present disclosure is not limited to the antenna 100. Suitable antennas for use in the RFID system 10 described in FIG. 1 may be realized through other embodiments, provided they resonate in multiple-modes in which two of the modes produce substantially divergent radiation patterns,

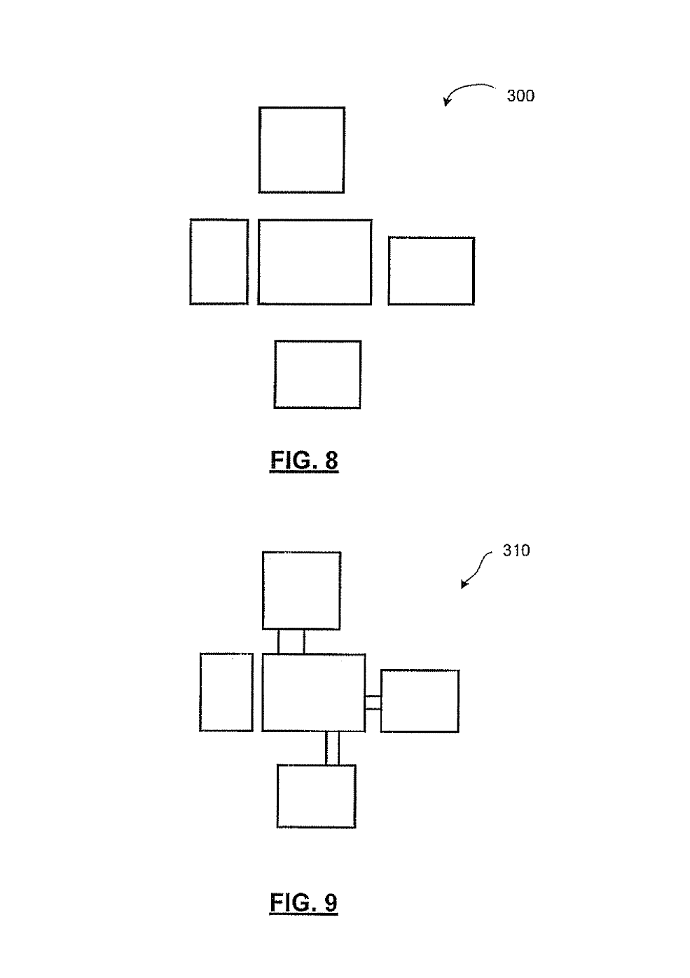

Reference is now made to FIG. 8, which illustrates a second antenna 300 according to the present description. The second antenna 300 includes a central rectangular patch and four parasitic rectangular patches each being spaced apart from an edge of the central patch. The parasitic patches are electromagnetically coupled, i.e, no direct electrical connection between patches.

FIG. 9 shows a third antenna 310 according to the present description. The third antenna 310 includes rectangular parasitic patches some of which are directly electrically connected to the central patch and some of which are electromagnetically coupled to the central patch.

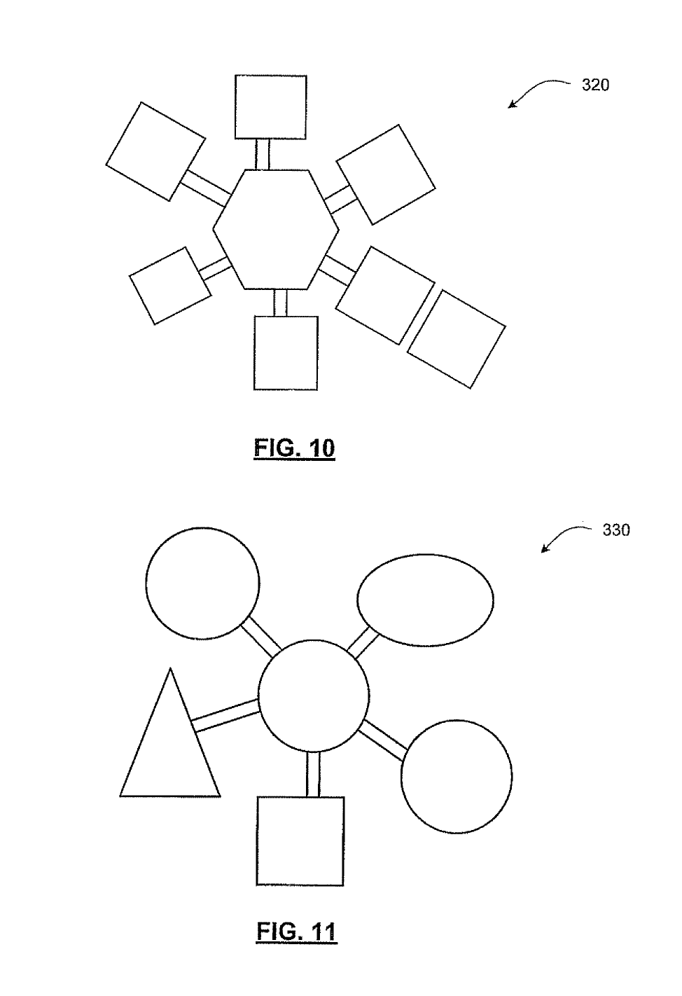

FIG. 10 shows a fourth antenna 320 according to the present description. The fourth antenna 320 comprises a yet more complex parasitic patch array. The central patch in the fourth antenna 320 is hexagonal, providing six sides for parasitic coupling. An additional parasitic patch is electromagnetically coupled to one of the direct coupled parasitic patches.

FIG. 11 shows a fifth antenna 330 according to the present description. The fifth antenna 330 is a direct coupled parasitic patch antenna in which the patches include circles, ovals, triangles, and other shapes.

In any of the above described embodiments, the antennas may be fed by a single RF feed point or by multiple feed points to excite additional modes.

From FIGS. 8 to 11, it will be appreciated that the size, shape, dimensions, spacing, and coupling lines of any particular parasitic patch array may be chosen so as to create the desired resonant modes producing the desired set of radiation patterns. Along with the choice of feed point location(s), these parameters may be selected so as to give rise to at least two substantially divergent radiation patterns at different resonant frequencies.

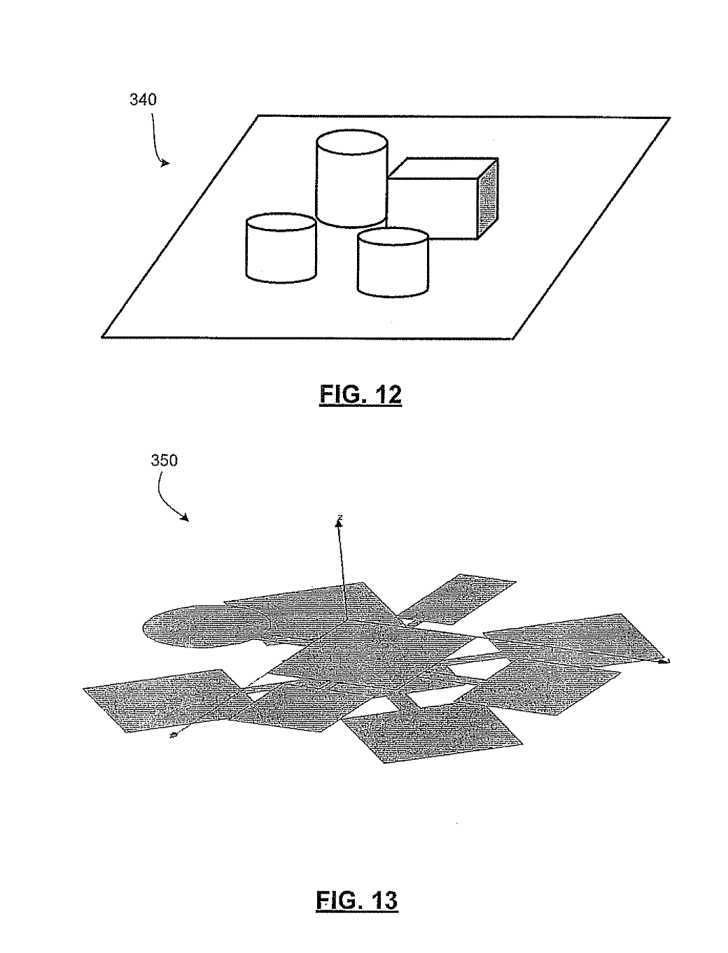

It will also be appreciated that the present disclosure is not limited to parasitic patch antennas, but may include any form of radiating structure arranged as a parasitic array. FIG. 12 diagrammatically illustrates an antenna 340 arranged as a parasitic array of arbitrarily shaped dielectric resonator structures. The structures may be directly coupled or electromagnetically coupled.

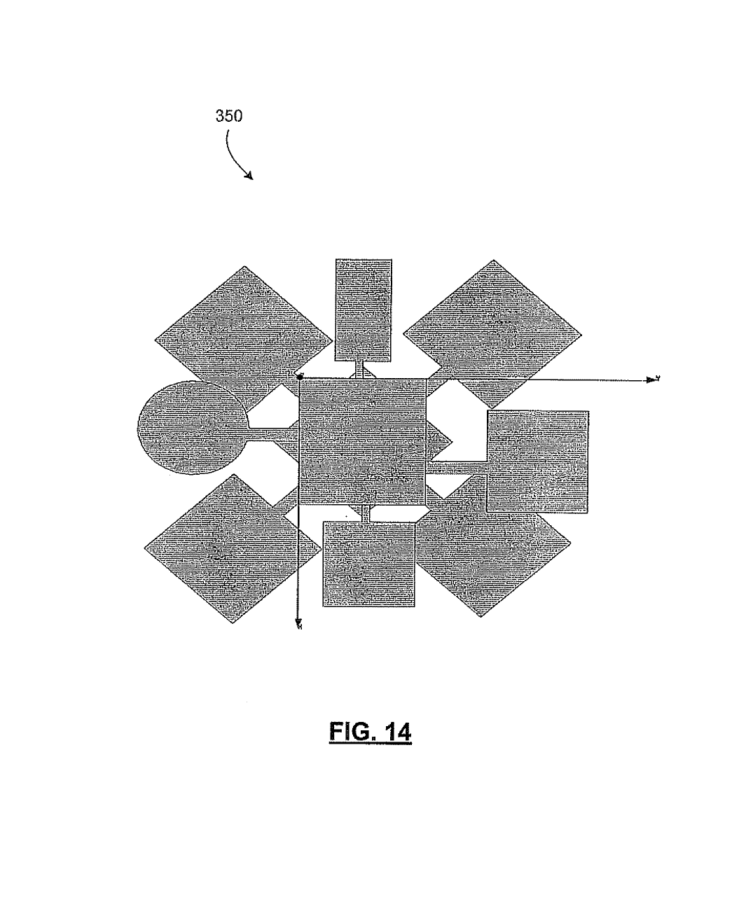

Additional degrees of freedom for developing additional resonant modes and radiation pattern shaping may be realized through a multi-layer antenna. FIG. 13 shows a perspective view of a multi-layer antenna 350. FIG. 14 shows a plan view of the multi-layer antenna 350 The multi-layer antenna 350 is formed as two parasitic patch antennas spaced apart and parallel to one another. The antenna 350 may use electromagnetic coupling, direct coupling, or a combination thereof.

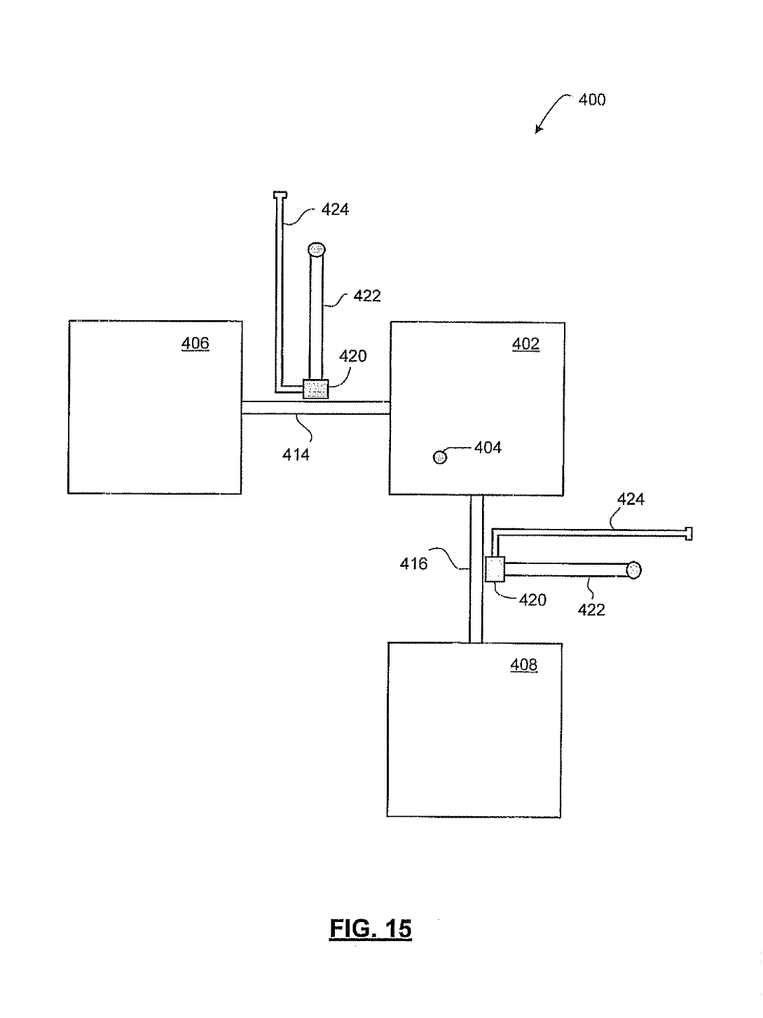

In yet another embodiment, an active switching element may assist in steering the radiation pattern. Reference is made to FIG. 15, which shows an embodiment of a switched antenna 400.

The switched antenna 400 includes a central patch 402, a first parasitic patch 406 arranged in an x-direction, and a second parasitic patch 408 arranged in a y-direction. The central patch 402 is coaxially fed along the diagonal, and one parasitic element couples to each degenerate mode. The parasitic patches 406 and 408 are directly connected to the central patch by coupling lines 414 and 416, respectively.

An RF switch 420 is positioned adjacent each coupling line 414, 416. Each of the RF switches 420 is configured to selectively load its respective coupling line 414, 416. In one embodiment, the RF switch 420 is a Radant MEMS SPST switch produced by RadantMEMS, Inc. of Massachusetts Wire bonds connect the RF switches 420 between the respective coupling line 414, 416 and a short-circuited transmission line 422. Electrically, the shorted line is equivalent to an open-circuited transmission line stub used to load the coupling line 414, 416 thus reducing the endfire resonant frequency. The stub is extended by a quarter wavelength at the patch resonant frequency and short-circuited to provide a DC ground to the RF switch 420. A relatively thin trace 424, isolated from the RF circuit, provides switching voltage to the RF switch 420.

When both switches 420 are off, the resonant frequencies of the parasitic elements coupled to both the resonant modes overlap There is a single endfire frequency at which the structure radiates simultaneously in the ±x and ±y directions. Closing a single switch 420 loads one of the coupling lines 414, 416, thus lowering the resonant frequency in only one direction. The result is the added ability to steer the antenna pattern while operating at a single frequency,

From the foregoing description, it will be appreciated that the frequency dependent directivity of the tag antenna described herein provides for an RFID system capable of selecting a frequency for a communications session with the tag. It will also be appreciated that, in some simple RFID systems no frequency selection is required because there are no reader-tag communications beyond the initial interrogation and response. In these instances, the above-described tag, reader, and RFID system still provide for improved range, sensitivity and possible reduction of nulls,

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. An antenna for radio frequency communications, comprising:
an active radiating element;
two or more additional radiating elements coupled to the active radiating element; and
a feed port connected to the active radiating element at a location,
wherein the antenna has a first resonant frequency with a first radiation pattern and a second resonant frequency with a second radiation pattern, and wherein the first radiation pattern and the second radiation pattern are substantially divergent in at least one plane,

2. The antenna claimed in claim 1, wherein the location of the feed port and the coupling of the additional radiating elements to the active element provide the antenna with at least two resonant modes corresponding to the first resonant frequency and the second resonant frequency, respectively.

3. The antenna claimed in claim 1, wherein said active radiating element and said two or more additional radiating elements comprise patches.

4. The antenna claimed in claim 3, wherein said patches comprise at least one square patch.

5. The antenna claimed in claim 1, wherein said active radiating element comprises a central patch having one or more centrelines, and wherein said location of said feed port is disposed other than on said centrelines.

6. The antenna claimed in claim 1, wherein said active radiating element and said two or more additional elements are configured such that the first radiation pattern and the second radiation pattern are substantially orthogonal in said at least one plane.

7. The antenna as claimed in claim 1, wherein the first radiation pattern and the second radiation pattern each comprise endfire mode radiation patterns.

8. The antenna as claimed in claim 7, wherein the first endfire mode radiation pattern is substantially orthogonal to the second endfire mode radiation pattern in said at least one plane.

9. The antenna as claimed in claim 1, wherein said active radiating element and said two or more additional radiating elements are configured to have a third resonant frequency having a broadside mode radiation pattern.

10. The antenna as claimed in claim 1, wherein said active radiating element comprises a central patch and wherein said additional radiating elements comprise at least two parasitic patches adjacent to and spaced apart from the central patch.

11. The antenna as claimed in claim 10, wherein said central patch comprises a centre square patch, and wherein said at least two parasitic patches comprise four square patches, each disposed along one of the sides of said centre square patch.

12. The antenna as claimed in claim 11, wherein said centre square patch and said four square patches all have the same dimensions.

13. The antenna as claimed in claim 12, wherein centre square patch has centrelines and wherein said four square patches are directly electrically coupled to said centre square patch by coupling lines disposed along said centrelines.

14. The antenna as claimed in claim 13, wherein said centrelines include a first centreline and a second centreline, and wherein said coupling lines along said first centreline have a first length, and said coupling lines along said second centreline have a second length, and wherein said first length and said second length differ sufficiently to provide electromagnetic isolation.

15. The antenna as claimed in claim 13, wherein said location of said feed port is disposed other than on said centrelines.

16. The antenna as claimed in claim 1, wherein said active radiating element comprises a splitter/combiner and wherein said additional radiating elements comprises individual antennas connected to said splitter/combiner.

17. A radio frequency identification (RFID) tag for use in an RFID system having a reader, the tag comprising:
an RFID transceiver; and
an antenna array having at least a first resonant frequency and a second resonant frequency, wherein the first resonant frequency has a first radiation pattern and the second resonant frequency has a second radiation pattern, and wherein the first radiation pattern and the second radiation pattern are substantially divergent in at least one plane, the antenna array having a feed port,
wherein the RFID transceiver includes a signal port connected to said feed port of the antenna array.

18. The RFID tag as claimed in claim 17, wherein the antenna array is configured such that the first radiation pattern and the second radiation pattern are substantially orthogonal in said at least one plane.

19. The RFID tag as claimed in claim 17, wherein the first radiation pattern and the second radiation pattern each comprise endfire mode radiation patterns.

20. The RFID tag as claimed in claim 17, wherein the antenna array comprises an active radiating element and two or more additional radiating elements coupled to the active radiating element, and wherein said feed port is connected to the active radiating element at a location and wherein the location of the feed port and the coupling of the additional radiating elements to the active element provide the antenna array with at least two resonant modes corresponding to said first resonant frequency and said second resonant frequency, respectively.

21. The RFID tag as claimed in claim 20, wherein said active radiating element comprises a central patch and wherein said additional radiating elements comprise at least two parasitic patches adjacent to and spaced apart from the central patch.

22. The RFID tag as claimed in claim 21, wherein said central patch comprises a centre square patch, and wherein said at least two parasitic patches comprise four square patches, each disposed along one of the sides of said centre square patch.

23. The RFID tag as claimed in claim 22, wherein said centre square patch and said four square patches all have the same dimensions.

24. The RFID tag as claimed in claim 23, wherein centre square patch has centrelines and wherein said four square patches are directly electrically coupled to said centre square patch by coupling lines disposed along said centrelines.

25. The RFID tag as claimed in claim 24, wherein said centrelines include a first centreline and a second centreline, and wherein said coupling lines along said first centreline have a first length, and said coupling lines along said second centreline have a second length, and wherein said first length and said second length differ sufficiently to provide electromagnetic isolation.

26. The RFID tag as claimed in claim 24, wherein said centre square patch has a horizontal centreline and a vertical centreline, and wherein said feed port is disposed at a location other then said horizontal centreline or said vertical centreline.

27. The RFID tag as claimed in claim 17, wherein said transceiver comprises a passive backscatter modulator.

28. A radio frequency identification (RFID) system, the system comprising:
a tag including an RFID transceiver and an antenna array having at least a first resonant frequency and a second resonant frequency, wherein the first resonant frequency has a first radiation pattern and the second resonant frequency has a second radiation pattern, and wherein the first radiation pattern and the second radiation pattern are substantially divergent in at least one plane, the antenna array having a feed port, wherein the RFID transceiver includes a signal port connected to said feed port of the antenna array; and
a reader, including a reader antenna and a reader transceiver, wherein the reader transceiver is configured to generate a first signal at said first resonant frequency and a second signal at said second resonant frequency, wherein the reader transceiver is coupled to the reader antenna for exciting the reader antenna to propagate RF energy to the tag at said first resonant frequency and said second resonant frequency.

29. The system claimed in claim 28, wherein the reader includes an interrogation component for controlling said reader transceiver, the interrogation component being configured to cause said reader transceiver to generate interrogation signals at said first resonant frequency and said second resonant frequency for propagation to said tag.

30. The system claimed in claim 29, wherein said interrogation component is configured to cause said interrogation signals to be generated sequentially.

31. The system claimed in claim 29, wherein said transceiver is configured to receive response signals from said tag and measure a signal strength of said response signals, and wherein said reader further includes a frequency selection module for determining whether said signal strength of said response signal is greater at said first resonant frequency or said second resonant frequency, and for basing a frequency selection for subsequent communications with said tag upon said determination.

32. The system claimed in claim 29, wherein said interrogation component is configured to operate said transceiver in accordance with a predetermined RFID communications protocol, and wherein said interrogation component applies said protocol in generating said sequential interrogation signals.

33. The system claimed in claim 29, wherein said transceiver is configured to receive response signals from said tag in response to said interrogation signals and measure a signal strength of each of said response signals, and wherein the reader further comprises a tag orientation module for determining the three-dimensional orientation of the tag based upon the relative signal strength measured for each of said response signals.

34. The system claimed in claim 28, wherein said RFID transceiver comprises a passive backscatter modulator.

35. A method of conducting RFID communications between a reader and one or more tags each having a multi-mode antenna array, the array having a first resonant frequency and a second resonant frequency, the reader being configured to generate and propagate RF signals at the first resonant frequency and the second resonant frequency, the method comprising the steps of:
propagating an interrogation signal at the first resonant frequency from the reader;
receiving a first response signal at the first resonant frequency;
propagating the interrogation signal at the second resonant frequency from the reader; and
receiving a second response signal at the second resonant frequency.

36. The method claimed in claim 35, wherein said first response signal and said second response signal are both received from a same one of said tags.

37. The method claimed in claim 36, further including steps of measuring the signal strength of said first response signal and measuring the signal strength of said second response signal, and identifying which of said response signals has the greater signal strength.

38. The method claimed in claim 37, further including a step of selecting the frequency of the response signal identified as having the greater signal strength as the frequency to be used for subsequent communications between the reader and said same one of said tags.

39. The method claimed in claim 37, further including a step of determining the three-dimensional orientation of the same one of said tags based upon the relative signal strength of said first response signal and said second response signal.

40. The method claimed in claim 35, wherein said step of propagating the interrogation signal at the second resonant frequency is performed a predetermined time following said step of propagating the interrogation signal at the first resonant frequency.
